(19) United States
(12) Patent Application Publication
(10) Pub. No.: US 2007/0127199 A1
(43) Pub. Date: Jun. 7, 2007

(54) Electronic device hinge mechanism

(76) Inventor: Theodore R. Arneson, Ivanhoe, IL (US)

Correspondence Address: MOTOROLA INC, 600 NORTH US HIGHWAY 45, ROOM AS437, LIBERTYVILLE, IL, 60048-5343, US

(21) Appl. No.: 11/295,041

(22) Filed: Dec. 6, 2005

(51) Int. Cl. G06F 1/16

(52) U.S. Cl. 361/683

(57) ABSTRACT

A handheld electronic device (100) having a first housing (102) and a second housing (104) is disclosed. The first housing and the second housing are interconnected by means of an extendable hinge mechanism (106). The first housing and the second housing are pivotally connected to the extendable hinge mechanism along a first axis A1 and a second axis A2, respectively. The extendable hinge mechanism enables the first housing to move between at least a first position and a second position.

### FIELD OF THE DISCLOSURE

The present invention relates generally to electronic devices, and more specifically to hinge mechanisms for handheld electronic devices.

### BACKGROUND OF THE DISCLOSURE

Handheld electronic devices have two housings, one of which is capable of being rotated relative to the other with a hinge mechanism, for example, clamshell mobile telephone handsets, are known generally. The housing portion capable of being rotated may be called a flip body, while the other housing may be called a fixed body. One or both of the housing portions may have electronic modules, for example, radio devices and user interfaces, etc.

Hinge mechanisms for handheld electronic devices are also known generally. US Patent Publication No. US 2004/0212956 A1, discloses a synchronizing module that allows a 360-degree rotation of a flip body about a fixed body. The synchronizing module includes interlocking gears connected to hinge modules connected to the flip and fixed bodies.

U.S. Patent Publication No. US 2004/0091101 A1 discloses a hinge mechanism enabling one of the two housings portions of a handheld electronic device to rotate 360 degrees about the other housing portion.

The various aspects, features and advantages of the disclosure will become more apparent to those having ordinary skill in the art upon careful consideration of the following Detailed Description thereof with the accompanying drawings described below.

### BRIEF DESCRIPTION OF THE DRAWINGS

FIG. 1 is a handheld electronic device in a first configuration.

FIG. 2 is a handheld electronic device in a second configuration.

FIG. 3 is an exemplary extendable hinge mechanism.

FIG. 4 is a portion of an extendable hinge mechanism.

FIG. 5 is another portion of an extendable hinge mechanism.

FIG. 6 is a partial sectional view of a handheld electronic device in a first configuration.

FIG. 7 is a partial sectional view of another handheld electronic device.

FIG. 8 is a partial sectional view of a handheld electronic device in another configuration.

FIG. 9 is a sectional view of an extendable hinge mechanism.

FIG. 10 is another sectional view of an extendable hinge mechanism in a first configuration.

FIG. 11 is another sectional view of an extendable hinge mechanism in a second configuration.

### DETAILED DESCRIPTION

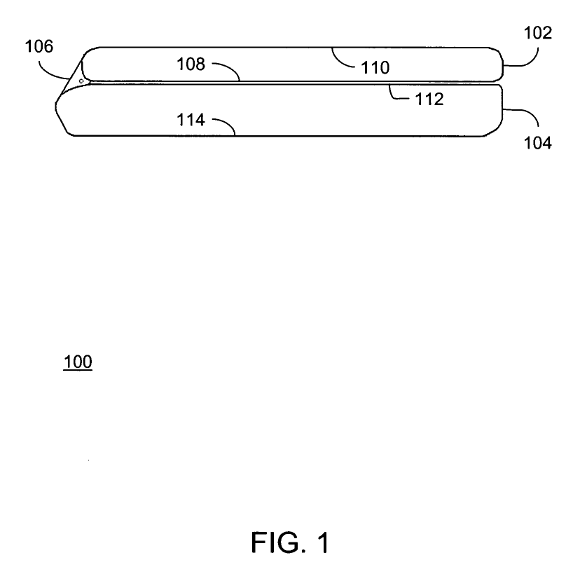

FIG. 1 is an illustrative handheld electronic device 100 having hinged housing portions in a first configuration. Examples of the handheld electronic device 100 include, but are not limited to, clamshell-type mobile phones and Personal Digital Assistants, laptop computers, etc. The handheld electronic device 100 includes a first housing portion 102 and a second housing portion 104 interconnected by a hinge mechanism 106.

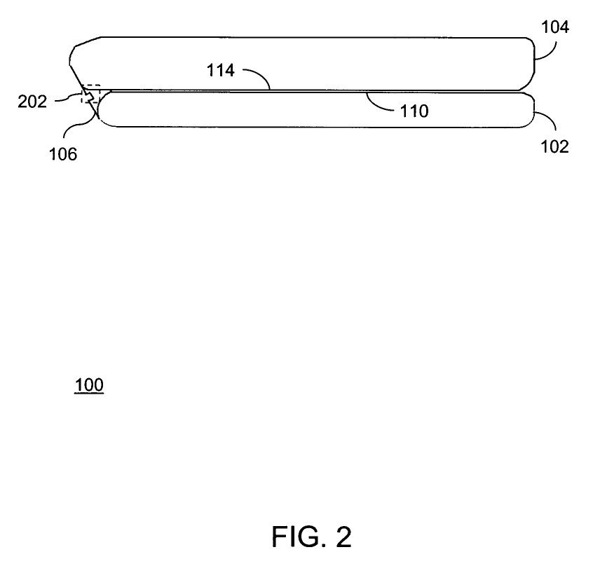

In one embodiment, the first housing portion 102 is a flip body capable of rotation relative to the second housing portion 104. The first housing portion 102 has a first side 108 and an opposite second side 110. The second housing portion 104 also has a first side 112 and a second side 114. The hinge mechanism 106 enables the first housing 102 to move relative to the second housing 104 between first and second positions or configurations. In one embodiment, the one of the housing portions is capable of rotation substantially 360 degrees relative to the other housing portion. In FIG. 1, in a first configuration, the first side 108 of the first housing portion 102 is adjacent to the first side 112 of the second housing portion 104. In FIG. 2, in a second configuration, the second side 110 of the first housing portion 102 is adjacent to the second side 114 of the second housing portion 104.

According to one aspect of the disclosure, the hinge mechanism is extendible to accommodate housing configurations that require different spacing between the pivot axes of the hinge mechanism. For example, an asymmetric housing portion may impose different spacing requirements on the hinge pivot axis depending upon the location of a second housing portion capable of rotating substantially 360 degrees relative to the first housing portion. In other applications, the thinness of one of both housing portions may be dependent upon an accessory, for example, a battery pack or keypad, removably fastened thereto. Illustrative housing configurations are discussed further below.

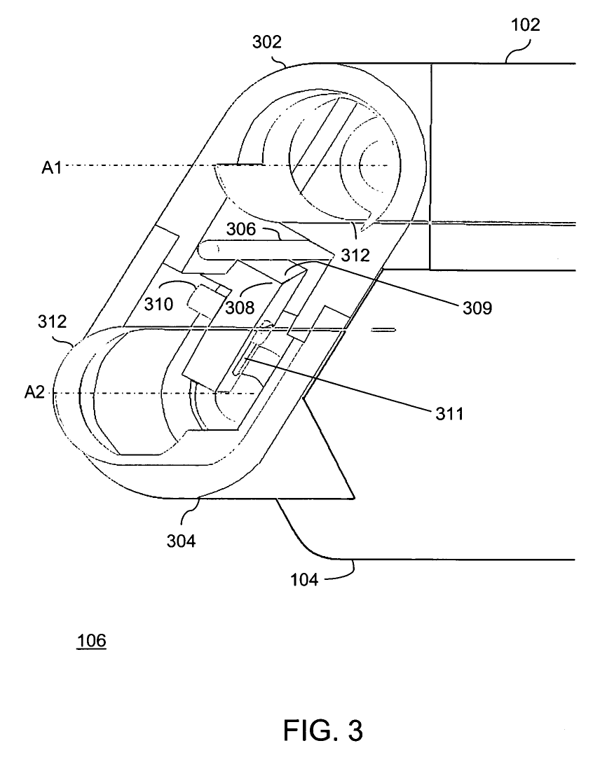

FIG. 3 is an illustrative extendable hinge mechanism 106 comprising a first hinge body 302, a second hinge body 304, and an elastic element 306. The first hinge body 302 is pivotally connected to the first housing 102 about a first axis A1. The second hinge body 304 is pivotally connected to the second housing 104 about a second axis A2.

In one embodiment, the first axis A1 is aligned with the mid-plane of the first housing 102, and the second axis A2 is aligned with the mid-plane of the second housing 104. In another embodiment, one or both of the axes A1 and/or A2 are not aligned with the mid-plane of the corresponding housing portions. According to this latter embodiment, as the first housing portion 102 pivots about the second housing portion 104, for example, from the configuration in FIG. 1 to the configuration in FIG. 2, the distance between the first and second hinge axes A1 and A2 changes. The hinge mechanism extends and retracts to accommodate different spacing between the hinge axes A1 and A2, depending on the configuration of the housing. The extendible hinge thus enables the first housing portion 102 to be rotated 360° around the second housing portion 104.

In FIG. 3, the first hinge body 302 and the second hinge body 304 are interconnected in a manner that permits reciprocation against the bias of the elastic element 306. In one embodiment, the elastic element 306 is a spring rod member captured between the hinge bodies in a manner that permits flexing of the element 306 as the hinge bodies reciprocate relative to each other. When the first hinge body 302 moves relative to the second hinge body 304, the elastic element exerts a force on the first and second hinge bodies that tends to return the hinge bodies to a biased position.

In one embodiment, a portion of the first hinge body 302 is telescopically disposed in the second hinge body 304. This aligns the first hinge body 102 with the second hinge body 104. A first element 308 is fixedly attached to, or protrudes from, the first hinge body 302 and includes a contact surface 309 engageable with a medial portion of the elastic element 306. The element 308 may be an integral part of the body 302 or it may be assembled therewith. As the first and second bodies 302 and 304 are moved apart from a neutral position, the contact surface 309 engages and flexes the spring rod, the ends of which are captured by the second hinge body 304. The elastic element 306 tends to bias the first and second bodies toward the neutral position. These and other aspects of the hinge are discussed below.

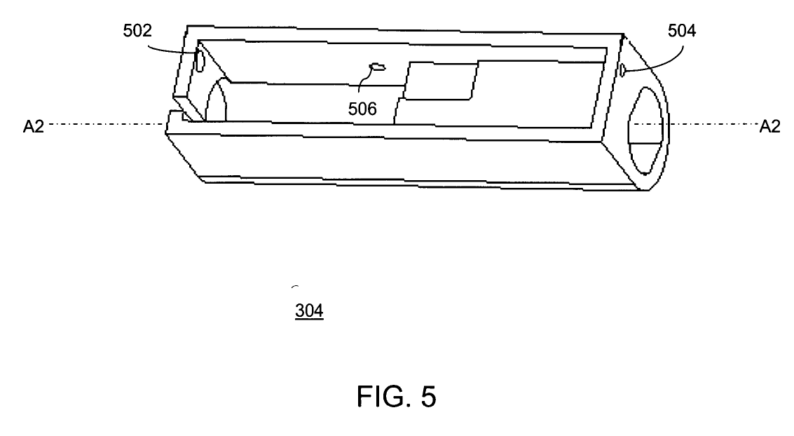

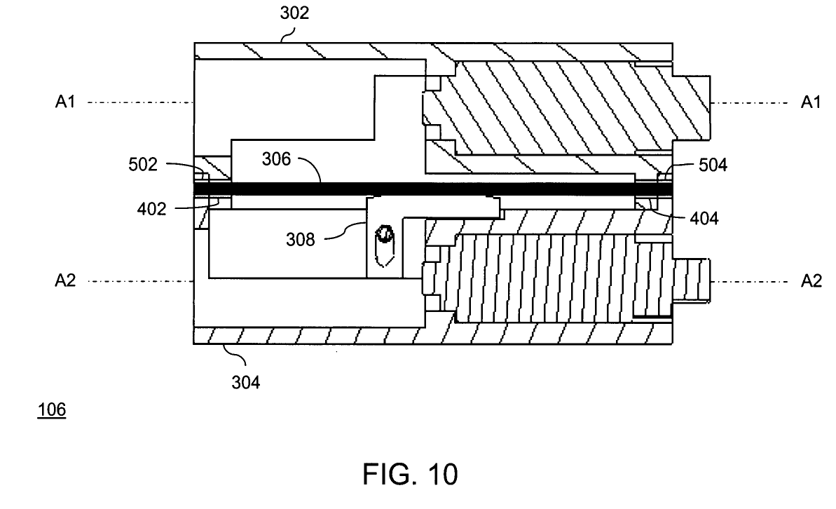

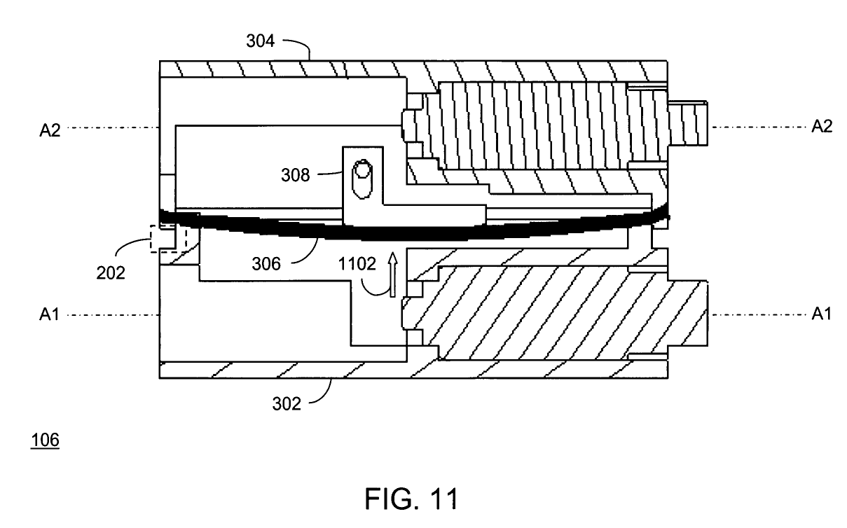

In FIG. 3, a second element 310 is fixedly attached to the second hinge body 304. The element 310 may be an integral part of the body 304 or it may be assembled therewith in the hole 506 shown in FIG. 5. The first element 308 is cooperatively engaged with the second element 310 in a manner that limits the distance between the first axis A1 and the second axis A2 when the first hinge body 302 and the second hinge body 304 are moved against the bias of the elastic element 306. In one embodiment, the first element 308 includes a slot 311 and the second element 310 is a stop pin reciprocatingly disposed within the slot. The maximum distance between the first axis A1 and the second axis A2 is restricted because of the limited positioning of the stop pin within the slot. The first element 308 and the second element 310 have been described further below in conjunction with FIGS. 10 and 11.

A flexible circuit 312 provides an electrical interconnection between the first housing 102 and the second housing 104. The electrical interconnection facilitates the communication of information, power, etc. between the first and second housing portions. The flexible circuit 312 can be a flexible conductor connected to electrical components in the first housing 102 at one end and to electrical components in the second housing 104 at another end.

In one embodiment, a portion of the flexible circuit 312 is routed through the extendable hinge mechanism 106. The portion of the flexible circuit 312 within the extendable hinge mechanism 106 is generally looped partially around at least one of the first axis A1 and the second axis A2. In FIG. 3, the portion of the flexible circuit 312 within the extendable hinge mechanism 106 coils and uncoils around the first axis A1 and the second axis A2, based on the movement of the first and second housing portions. In FIG. 3, when the housing portions are in one configuration, the portion of the flexible circuit 312 within the extendable hinge mechanism 106 is looped less than 360 degrees around the axis A2 and it is looped more than 360 degrees around the other axis A1. When the housing portion 102 is rotated 360 counterclockwise relative to housing portion 104, the portion of the flexible circuit 312 within the extendable hinge mechanism 106 is looped more than 360 degrees around the axis A2 and it is looped less than 360 degrees around the axis A1.

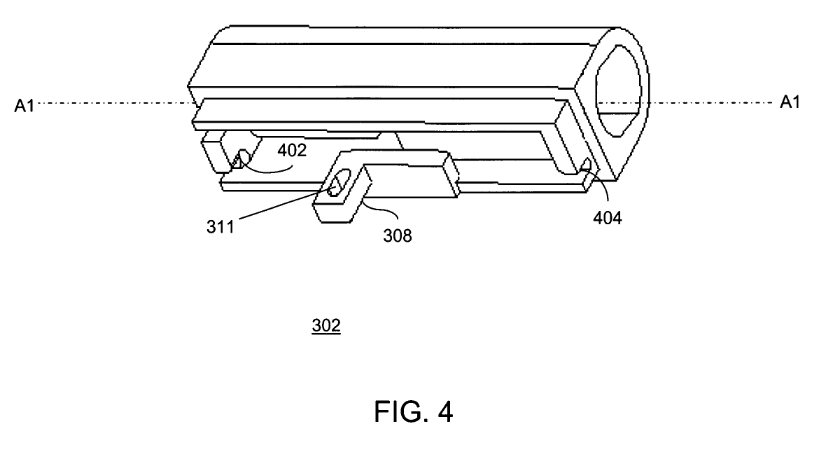

FIG. 4 illustrates the first hinge body 302. The elastic element (not shown in FIG. 4) passes through a first clearance slot 402 at one end and a second clearance slot 404 at the other. The clearance slots 402 and 404 provide space for the movement of the elastic element when the handheld electronic device is in the second position. FIG. 5 illustrates the second hinge body 304. The elastic element (not shown in FIG. 4) passes through a clearance slot 502 and is disposed in a first slot 504. The pin (shown as 310 in FIG. 3) is fixedly disposed in a second slot 506, and is disposed through the slot 311 in FIG. 4 to limit extension of the hinge as discussed above.

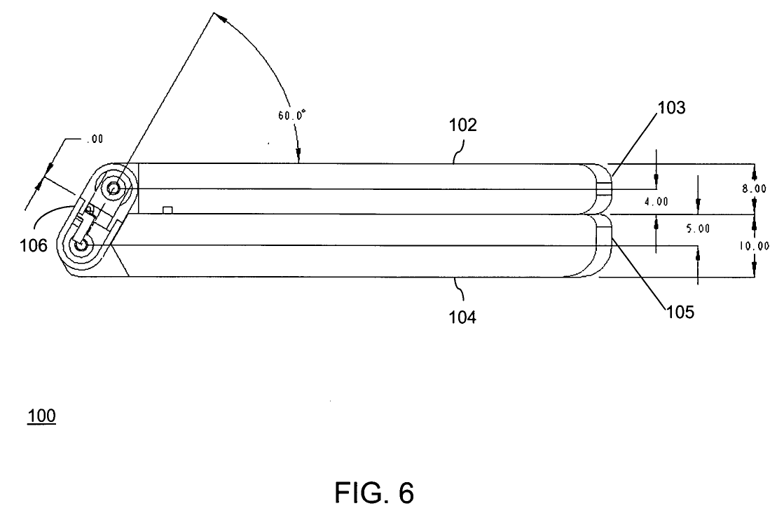

FIG. 6 is a side view of a handheld electronic device 100 in a first configuration. In this embodiment, the first axis A1 and the second axis A2 are aligned to the mid-plane of the housings portions 102 and 104, respectively. In this embodiment, the extendable hinge mechanism 106 is at an angle of 60° relative to the surface of the first housing 102 when the end surfaces 103 and 105 of the housing are aligned relative to a vertical plane. The extendable hinge mechanism 106 is not extended in the first configuration.

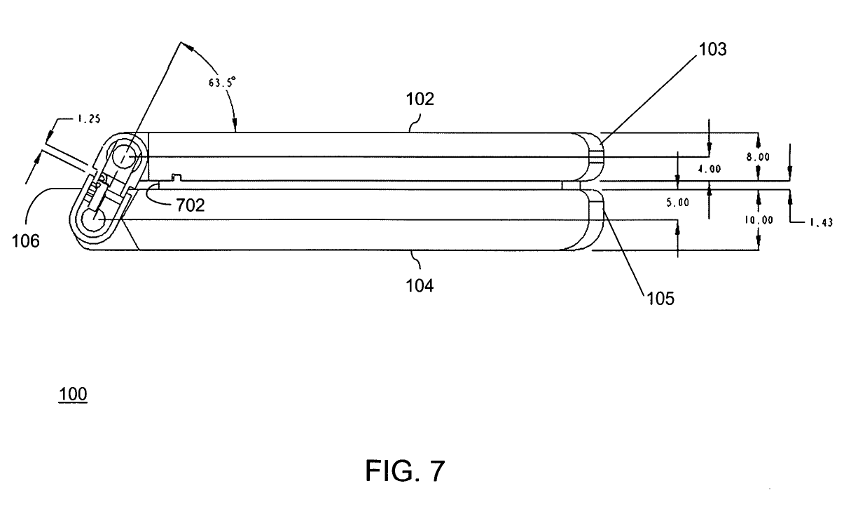

FIG. 7 is a view of the handheld electronic device 100 having a touch pad 702 on a face of the second housing portion 104. In this embodiment, the touch pad 702 increases the spacing between the housing portions 102 and 104. The extendable hinge mechanism 106 must be extended to accommodate the touch pad 702 when the end surfaces 103 and 105 of the housing are aligned relative to a vertical plane. Further, the angle between the extendable hinge mechanism 106 and the first housing portion 102 increases to 63.5° when the end surfaces 103 and 105 of the housing portions are aligned relative to the vertical plane.

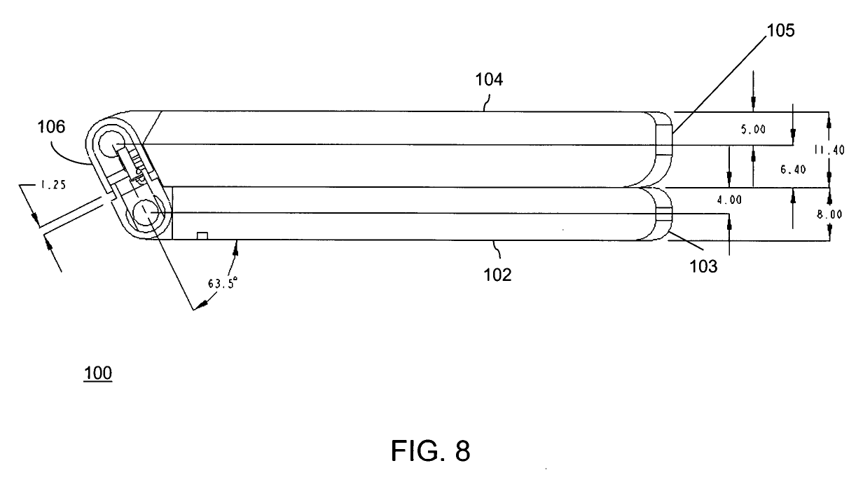

FIG. 8 is a view of the handheld electronic device 100 in the second configuration. In this embodiment, the pivot axis is asymmetrically located relative to the mid-plane of the housing portion 106. The asymmetry may be due to the location of the pivot axis or result from the use of different removable battery packs having different thicknesses or from the use of other accessories. The hinge mechanism 106 must be extended to accommodate the thicker side of housing portion 104 when the thicker side of housing portion 104 is mated with housing portion 102. Also, the angle between the extendable hinge mechanism 106 and the first housing portion 102 increases to 63.5° in order to maintain the alignment of the housing end portion 103 and 105.

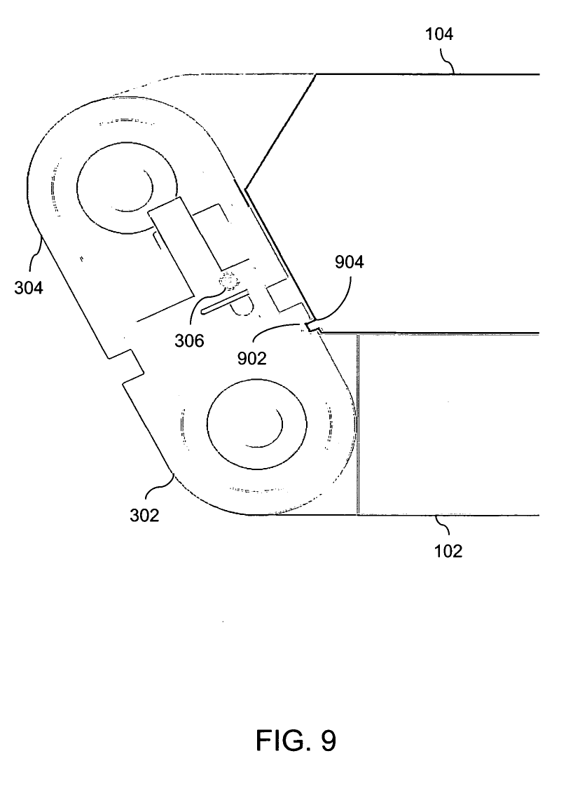

FIG. 9 is an illustrative handheld electronic device 100. The handheld electronic device 100 includes a stop feature, which secures the handheld electronic device 100 in the second configuration against the bias of the elastic member 306. In one embodiment, the stop feature secures the first housing portion 102 and the second housing portion 104 in a desired configuration. The stop feature includes a first alignment member 902 and a second alignment member 904. The first alignment member 902 and the second alignment member 904 cooperatively engage to secure the first housing 102 and the second housing 104 in a predetermined configuration, for example, so that ends of the housing first and second portions are aligned with a vertical plane as discussed above. In FIG. 9, the first alignment member 902 is a depression in the first housing 102 and the second alignment member 904 is a protrusion in the second housing 104. The predetermined configuration of the first and second housing portions is secured when the protrusion fits into the depression. In an embodiment, the first alignment member 902 is a depression in the first hinge body 302. In another embodiment, the second alignment member is a protrusion on the housing portion or on an accessory coupled thereto, for example, a battery pack or a touch pad.

FIG. 10 illustrates the hinge mechanism 106 when the handheld electronic device 100 is in the first configuration. The extendable hinge mechanism 106 includes the first hinge body 302, the second hinge body 304, and the elastic member 306. The elastic member 306 remains in contact with a face of the first element 308, as shown in FIG. 10. The elastic member 306 passes through a first clearance slot 402 of the first hinge body 302 and the clearance slot 502 of the second hinge body 304 at one end of the extendable hinge mechanism 106. The elastic member 306 passes through the second clearance slot 404 of the first hinge body 302 and is fixedly attached in the first slot 504 of the second hinge body 304 at the other end of the hinge mechanism 106.

FIG. 11 illustrates the extendable hinge mechanism 106 when the handheld electronic device 100 is in the second configuration, which is extended relative to the first configuration of FIG. 10. The first hinge body 302 is displaced relative to the second hinge body 304, against the bias of the elastic member 306, increasing the distance between the first axis A1 and the second axis A2. This causes the elastic member 306 to deflect or bend, as the face of the first element 308 pushes the elastic member 306 away to an extended position. The elastic member 306 therefore tries to force the first hinge body in a direction 1102. The displacement of the first hinge body 302, relative to the second hinge body 304, forms the gap 202 between the first hinge body 302 and the second hinge body 304. Further, the stop pin inserted in the slot in the first element 308 moves towards a farther end of the slot, preventing any further movement of the first hinge body 302 away from the second hinge body 304.

The extendible hinge mechanism described above enables the first housing portion of a handheld electronic device 100 to rotate approximately 360 degrees around a second housing portion when one or both of the hinge pivot axes are asymmetrically aligned with the mid-plane of the housing portion.

While the present disclosure and the best modes thereof have been described in a manner establishing possession by the inventors and enabling those of ordinary skill in the art to make and use the same, it will be understood and appreciated that there are many equivalents to the exemplary embodiments disclosed herein and that modifications and variations may be made thereto without departing from the scope and spirit of the invention, which is to be limited not by the exemplary embodiments but by the appended claims.

What is claimed is:

1. A handheld electronic device comprising:
a first housing;
a second housing; and
an extendable hinge mechanism pivotally connected to the first housing along a first axis, the extendable hinge mechanism pivotally connected to the second housing along a second axis,
wherein the extendable hinge mechanism is movable between at least a first position and a second position, wherein a distance between the first axis and the second axis of the extendable hinge mechanism is different in the second position than when in the first position.

2. The handheld electronic device of claim 1, wherein the extendable hinge mechanism comprises:
a first hinge body pivotally connected to the first housing along the first axis;
a second hinge body pivotally connected to the second housing along the second axis; and
an elastic element interconnecting the first hinge body and the second hinge body, the elastic element biasing the first hinge body relative to the second hinge body.

3. The handheld electronic device of claim 2, wherein the elastic element is a spring interconnecting the first hinge body and the second hinge body, the spring allowing the first hinge body to move relative to the second hinge body such that the distance between the first axis and the second axis changes.

4. The handheld electronic device of claim 2, wherein the first hinge body is partially and telescopically disposed within a portion of the second hinge body.

5. The handheld electronic device of claim 2 further comprises:
a first element in the first hinge body; and
a second element in the second hinge body,
wherein the first element is cooperatively engageable with the second element to limit the distance between the first axis and the second axis when the first hinge body and the second hinge body are moved against a bias of the elastic member.

6. The handheld electronic device of claim 1, further comprising:
a first alignment member in the first housing; and
a second alignment member in the second housing,
wherein the first alignment member and the second alignment member cooperatively engage to align the first housing and the second housing in a predetermined configuration.

7. The handheld electronic device of claim 6, wherein the first alignment member is a depression and the second alignment member is a protrusion, a mating configuration of the first housing and the second housing is secured when the protrusion is disposed into the depression.

8. The handheld electronic device of claim 1 further comprising a flexible circuit interconnecting the first housing and the second housing, the flexible circuit having a portion disposed at least partially within the extendable hinge mechanism, the portion of the flexible circuit disposed within the extendable hinge mechanism looped at least partially around at least one of the first axis and the second axis.

9. The handheld electronic device of claim 1, wherein the extendable hinge mechanism is in the first position when a first side of the first housing is adjacent to a first side of the second housing and the extendable hinge mechanism is in the second position when a second side of the first housing is adjacent to a second side of the second housing.

10. The handheld electronic device of claim 9 further comprises a flexible circuit interconnecting the first housing and the second housing, wherein a portion of the flexible circuit is disposed within the extendable hinge mechanism, the portion of the flexible circuit is looped less than 360 degrees about one of the first axis and the second axis when the extendable hinge mechanism is in the first position and the portion of the flexible circuit is looped more than 360 degrees about one of the first axis and the second axis when the extendable hinge mechanism is in the second position.

11. The handheld electronic device of claim 1, wherein the first axis of the extendable hinge mechanism is aligned with the mid-plane of the first housing and the second axis of the extendable hinge mechanism is aligned offset to the mid-plane of the second housing.

12. An extendable hinge mechanism for interconnecting a first housing and a second housing of a handheld electronic device, the extendable hinge mechanism comprising:
a first hinge body pivotally connected to the first housing about a first axis;
a second hinge body pivotally connected to the second housing about a second axis; and
an elastic element interconnecting the first hinge body and the second hinge body, the elastic element biasing the first hinge body relative to the second hinge body.

13. The extendable hinge mechanism of claim 12, wherein the elastic element is a spring interconnecting the first hinge body and the second hinge body, the spring allowing the first hinge body to move relative to the second hinge body such that a distance between the first axis and the second axis changes.

14. The extendable hinge mechanism of claim 12 further comprising:
a first element in the first hinge body; and
a second element in the second hinge body,
wherein the first element is cooperatively engageable with the second element to limit a distance between the first axis and the second axis when the first hinge body and the second hinge body are moved against a bias of the elastic member.

15. The extendable hinge mechanism of claim 12, further comprising a flexible circuit interconnecting the first housing and the second housing, the flexible circuit having a portion disposed at least partially within the extendable hinge mechanism and the portion of the flexible circuit is looped at least partially about at least one of the first axis and the second axis.

16. The extendable hinge mechanism of claim 15, wherein a first portion of the flexible circuit disposed within the extendable hinge mechanism loops at least partially about the first axis, and a second portion of the flexible circuit disposed within the extendable hinge mechanism loops at least partially about the second axis.
